(19) United States
(12) Patent Application Publication
(10) Pub. No.: US 2025/0294060 A1
(43) Pub. Date: Sep. 18, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yoshiyuki YODA, Kanagawa (JP)

(73) Assignee: FUJIFILM Business Innovation Corp., Tokyo (JP)

(21) Appl. No.: 18/808,220

(22) Filed: Aug. 19, 2024

(30) Foreign Application Priority Data
Mar. 13, 2024 (JP) 2024-038929

(51) Int. Cl. H04L 9/40

(52) U.S. Cl. CPC H04L 63/20

(57) ABSTRACT

An information processing system includes a processor configured to: transmit inquiry information from an operating terminal of an information processing apparatus to the information processing apparatus according to a predetermined security scheme; and, upon receiving response information according to another security scheme different from the security scheme from the information processing apparatus, transmit the inquiry information to the information processing apparatus according to the same security scheme as the other security scheme.

### CROSS-REFERENCE TO RELATED APPLICATIONS

This application is based on and claims priority under 35 USC 119 from Japanese Patent Application No. 2024-038929 filed Mar. 13, 2024.

### BACKGROUND

### (i) Technical Field

The present disclosure relates to an information processing system and a non-transitory computer readable medium.

### (ii) Related Art

Japanese Unexamined Patent Application Publication No. 2006-251996 discloses a client apparatus configured to communicate with an external image processing apparatus over a network, the client apparatus characterized by being provided with: negotiation means that negotiates with the image processing apparatus in regard to an authentication scheme when requesting the image processing apparatus to process an image; and authentication information transmission means that, when it is determined in the negotiation that authentication is to be performed outside the image processing apparatus, encrypts authentication information to be used for authentication according to a scheme that is processible by basic functions of the image processing apparatus and transmits the encrypted authentication information to the image processing apparatus, and when it is determined in the negotiation that authentication is to be performed inside the image processing apparatus, transmits the authentication information to the image processing apparatus in a format suitable for digest authentication.

Japanese Unexamined Patent Application Publication No. 2009-110261 discloses a network management apparatus that communicates with a peripheral apparatus using a version of Simple Network Management Protocol (SNMP) that requires key information in communication, the network management apparatus characterized by including: means for acquiring device-specific information from the peripheral apparatus; means for generating multiple key information candidates using the device-specific information, before communicating by SNMP; means for acquiring an SNMP engine ID of the peripheral apparatus; determining means that determines whether the SNMP engine ID corresponds to the device-specific information; and communicating means that, when the determining means has determined that the SNMP engine ID corresponds to the device-specific information, retains the SNMP engine ID and communicates by SNMP using key information corresponding to the device-specific information selected from among the key information candidates.

Japanese Unexamined Patent Application Publication No. 2009-301111 discloses a network device management apparatus characterized by including: searching means that searches for a network device that supports a first communication protocol; authentication information inputting means that inputs authentication information for communicating with the network device according to the first communication protocol; authentication executing means that uses the authentication information to authenticate the network device; first confirming means that, upon successful authentication by the authentication executing means, confirms whether or not a second communication protocol different from the first communication protocol is enabled in the network device; and settings changing means that changes settings of the second communication protocol according to a confirmation result from the first confirming means.

### SUMMARY

Aspects of non-limiting embodiments of the present disclosure relate to the following: when transmitting inquiry information from an operating terminal to an image processing apparatus according to a common security scheme, even if the security scheme of the image processing apparatus is unknown, identifying the security scheme of the image processing apparatus without repeatedly transmitting inquiry information from the operating terminal to the image processing apparatus while changing the security scheme.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including a processor configured to: transmit inquiry information from an operating terminal of an information processing apparatus to the information processing apparatus according to a predetermined security scheme; and, upon receiving response information according to another security scheme different from the security scheme from the information processing apparatus, transmit the inquiry information to the information processing apparatus according to the same security scheme as the other security scheme.

### BRIEF DESCRIPTION OF THE DRAWINGS

An exemplary embodiment of the present disclosure will be described in detail based on the following figures, wherein:

FIG. 1 is a diagram illustrating a schematic configuration of an image processing system according to an exemplary embodiment;

FIG. 2 is a block diagram illustrating a hardware configuration of the image processing apparatus illustrated in FIG. 1;

FIG. 3 is a block diagram illustrating a hardware configuration of the operating terminal illustrated in FIG. 1;

FIG. 4 is a functional block diagram of the image processing apparatus and the operating terminal illustrated in FIG. 1;

FIG. 5 is a diagram illustrating an example of a settings information management table in the operating terminal illustrated in FIG. 1;

FIG. 6 is a diagram illustrating an example of combinations of security schemes in the operating terminal illustrated in FIG. 1;

FIG. 7 is a flowchart illustrating the flow of an apparatus information acquisition process by the operating terminal illustrated in FIG. 1; and

FIG. 8 is a flowchart illustrating the flow of a response process by the image processing apparatus illustrated in FIG. 1.

### DETAILED DESCRIPTION

The following describes an exemplary embodiment while referring to the drawings. Note that in the drawings, identical or similar components and portions are denoted with the same reference signs. Also, the dimension ratios in the drawings are exaggerated for explanatory convenience, and may be different from the actual ratios in some cases.

### (Overview of Image Forming System)

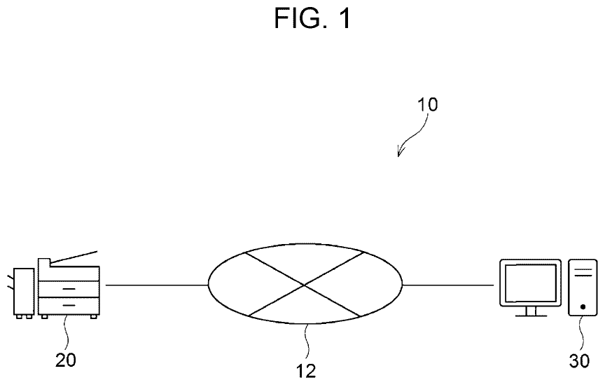

FIG. 1 illustrates an image forming system 10 according to the exemplary embodiment. The image forming system 10 includes an image processing apparatus 20 as an example of an information processing apparatus, and an operating terminal 30. The image processing apparatus 20 and the operating terminal 30 are connected to a network 12.

The network 12 is an internal network such as a local area network (LAN) or a wide area network (WAN), or an external network such as the Internet. Through the network 12, the image processing apparatus 20 and the operating terminal 30 are communicatively connected to each other.

Simple Network Management Protocol version 3 (SNMPv3) is implemented in the image processing apparatus 20 and the operating terminal 30. In addition, the operating terminal 30 is configured to follow SNMPv3 to acquire various information from a management information base (MIB) in the image processing apparatus 20.

Also, SNMPv3 allows for authentication according to an authentication protocol. Examples of the authentication protocol include message-digest algorithm 5 (MD5) and the Secure Hash Algorithms SHA-1 and SHA-256. Additionally, SNMPv3 allows for encrypted communication (message encryption). Examples of encrypted communication include the Data Encryption Standard (DES) and the Advanced Encryption Standards AES-128 and AES-256.

Note that the image processing apparatus 20 and the operating terminal 30 are one example of an information processing system. The “system” in the exemplary embodiment is a concept that refers to both a configuration formed by multiple apparatuses and a configuration formed by a single apparatus. In FIG. 1, one image processing apparatus 20 and one operating terminal 30 are illustrated as an example. However, multiple image processing apparatuses 20 and multiple operating terminals 30 may also be present.

### (Image Processing Apparatus)

As an example, the image processing apparatus 20 is a printer on the network 12, the printer having an image printing function for acquiring image data from the operating terminal 30 and printing acquired image data onto a recording medium such as paper. The image processing apparatus 20 may also be, for example, a multi-function peripheral having at least one from among multiple functions such as an image reading (scan) function, an image duplicating (copy) function, an image transmitting (facsimile) function, and the like, in addition to the image printing function described above.

### (Operating Terminal)

As an example, the operating terminal 30 is an information processing terminal operated by a user who uses the image processing apparatus 20. The operating terminal 30 is a personal computer, a laptop, a smartphone, or the like.

### (Hardware Configuration of Image Processing Apparatus)

Next, a hardware configuration of the image processing apparatus 20 will be described.

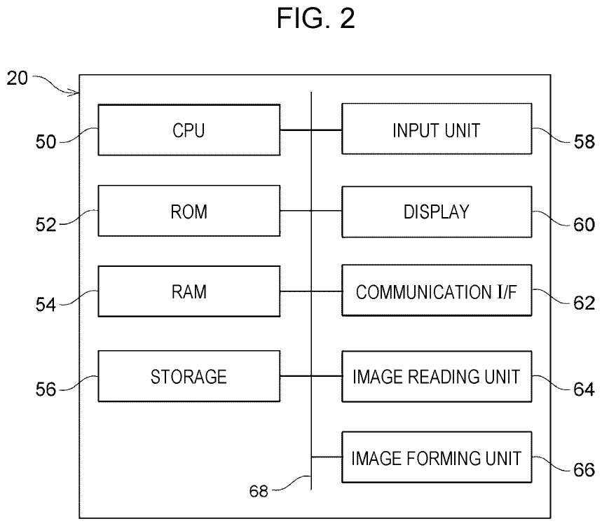

As illustrated in FIG. 2, the image processing apparatus 20 includes the following components: a central processing unit (CPU) 50, read-only memory (ROM) 52, random access memory (RAM) 54, storage 56, an input unit 58, a display 60, a communication interface (I/F) 62, an image reading unit 64, and an image forming unit 66. These components are communicatively interconnected through a bus 68.

The CPU 50 is a central processing unit that executes various programs and controls each unit. That is, the CPU 50 reads out a program from the ROM 52 or the storage 56, and executes the program while using the RAM 54 as a work area. The CPU 50 controls each component as above and performs various arithmetic processing in accordance with the program recorded in the ROM 52 or the storage 56. Note that the CPU 50 is an example of a processor.

The ROM 52 stores various information processing programs and various data. The RAM 54 temporarily stores programs or data as a work area for the CPU 50.

The storage 56 includes a hard disk drive (HDD) or a solid-state drive (SSD), and stores various programs, including an operating system, as well as various data. The storage 56 also stores a response processing program.

The input unit 58 includes operation buttons or the like, and is used to enter various inputs. The display 60 is a liquid crystal display, for example, and displays various information. The display 60 may also adopt a touch panel system and function as an input unit.

The communication I/F 62 is an interface for communicating with other equipment, and implements a standard such as Ethernet®, FDDI, or Wi-Fi®, for example.

The image reading unit 64 optically reads image data from a document or the like. The image forming unit 66 prints image data onto a recording medium such as paper, the image data being image data read by the image reading unit 64 or received from the operating terminal 30. Note that the image reading unit 64 also functions as an input unit.

### (Hardware Configuration of Operating Terminal)

Next, a hardware configuration of the operating terminal 30 will be described.

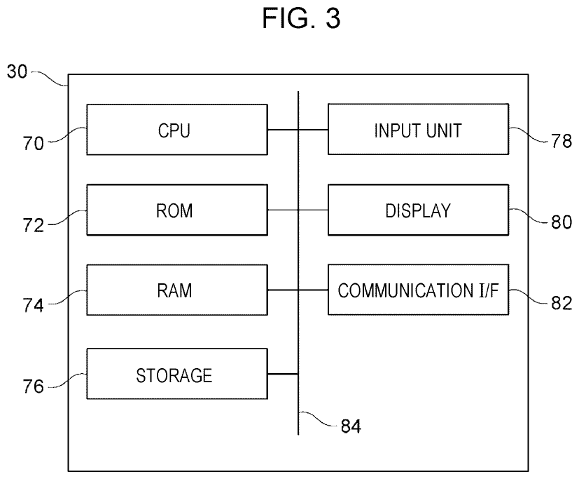

As illustrated in FIG. 3, the operating terminal 30 includes the following components: a CPU 70, RAM 72, RAM 74, storage 76, an input unit 78, a display 80, and a communication interface (I/F) 82. These components are communicatively interconnected through a bus 84.

The CPU 70 is a central processing unit that executes various programs and controls each unit. That is, the CPU 70 reads out a program from the ROM 72 or the storage 76, and executes the program while using the RAM 74 as a work area. The CPU 70 controls each component as above and performs various arithmetic processing in accordance with the program recorded in the ROM 72 or the storage 76. Note that the CPU 70 is an example of a processor.

The ROM 72 stores various information processing programs and various data. The RAM 74 temporarily stores programs or data as a work area for the CPU 70.

The storage 76 includes an HDD or an SSD, and stores various programs, including an operating system, as well as various data. The storage 76 also stores an apparatus information acquisition processing program.

The input unit 78 includes a mouse or other pointing device and a keyboard, and is used to enter various inputs. The display 80 is a liquid crystal display, for example, and displays various information. The display 80 may also adopt a touch panel system and function as an input unit.

The communication I/F 82 is an interface for communicating with other equipment, and implements a standard such as Ethernet®, FDDI, or Wi-Fi®, for example.

### (Functions of Image Processing Apparatus)

Next, functions of the image processing apparatus 20 will be described.

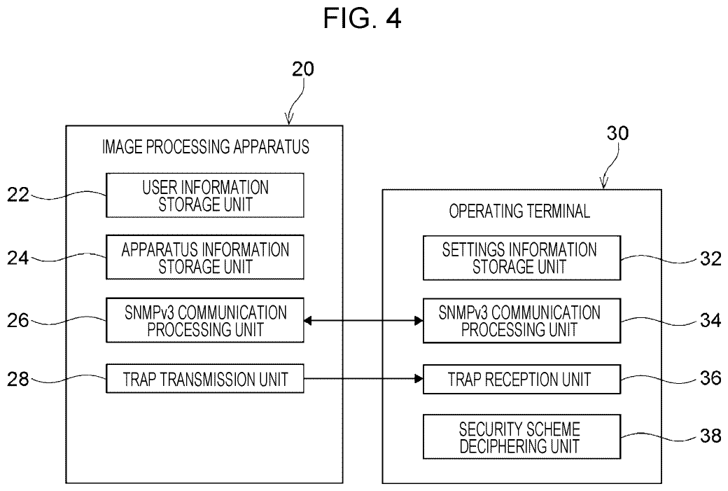

When executing the information processing programs described above, the image processing apparatus 20 uses the abovementioned hardware resources to realize various functions. Specifically, as illustrated in FIG. 4, the image processing apparatus 20 functionally includes a user information storage unit 22, an apparatus information storage unit 24, an SNMPv3 communication processing unit 26, and a trap transmission unit 28.

### (User Information Storage Unit)

The user information storage unit 22 stores a user management table, in which a user ID and a password assigned to a user of the image processing apparatus 20 are registered. The user management table is configured as an SNMPv3 MIB, for example, and is updated as needed.

### (Apparatus Information Storage Unit)

The apparatus information storage unit 24 stores an apparatus information management table in which various information about the image processing apparatus 20 is registered. Examples of the various information about the image processing apparatus 20 include: basic information, such as the printing method, the number of paper feed trays, and the number of paper exit trays; and status information indicating the operating state of the image processing apparatus 20, such as a normal mode and a power-saving mode. The apparatus management table is configured as an SNMPv3 MIB, for example, and is updated as needed.

### (SNMPv3 Communication Processing Unit)

The SNMPv3 communication processing unit 26 is configured to transmit and receive various data to and from the operating terminal 30 according to SNMPv3. Specifically, the SNMPv3 communication processing unit 26 receives inquiry information from the operating terminal 30 as an SNMPv3 information request, and transmits response information to the operating terminal 30 in response to the inquiry information.

At this time, the SNMPv3 communication processing unit 26 authenticates the user of the operating terminal 30 on the basis of user authentication information included in the inquiry information from the operating terminal 30, namely the user ID and password of the user. Specifically, the SNMPv3 communication processing unit 26 checks the user ID and password of the user received from the operating terminal 30 against the user ID and password registered in the user management table.

If the user ID and password of the user received from the operating terminal 30 exists in the user management table, the SNMPv3 communication processing unit 26 deems the authentication to be successful. The SNMPv3 communication processing unit 26 then reads out, from the apparatus information management table, various information about the image processing apparatus 20 included in the inquiry information received from the operating terminal 30, and transmits the read information to the operating terminal 30 as response information.

On the other hand, if the user ID and password of the user received from the operating terminal 30 does not exist in the user management table, the SNMPv3 communication processing unit 26 deems the authentication to be unsuccessful, and transmits response information to that effect to the operating terminal 30. At this time, the SNMPv3 communication processing unit 26 does not transmit various information about the image processing apparatus 20 to the operating terminal 30.

The SNMPv3 communication processing unit 26 also transmits and receives various data to and from the operating terminal 30 according to an SNMPv3 security scheme. At this time, the SNMPv3 communication processing unit 26 deciphers inquiry information received from the operating terminal 30 according to a security scheme set in the image processing apparatus 20. The security scheme is a combination of an authentication scheme and an encryption scheme.

As described above, examples of the authentication scheme (authentication protocol) include MD-5, SHA-1, and SHA-256. Examples of the encryption scheme include DES, AES-128, and AES-256.

The security scheme is preset in the image processing apparatus 20, and is registered in the apparatus information management table described above, for example. In the image processing apparatus 20 according to the exemplary embodiment, SHA-1 and AES-128 are set as one example of the security scheme.

The SNMPv3 communication processing unit 26 is able to decipher the authentication information received from the operating terminal 30 and read the user authentication information and the like included in the inquiry information only if the security scheme of the inquiry information received from the operating terminal 30 matches the security scheme set in the image processing apparatus 20.

In other words, if the security scheme of the inquiry information received from the operating terminal 30 does not match the security scheme set in the image processing apparatus 20, the SNMPv3 communication processing unit 26 is unable to decipher the inquiry information received from the operating terminal 30 and is unable to read the user authentication information and the like included in the inquiry information. In this case, according to the SNMPv3 standard (RFC), response information is not transmitted to the operating terminal 30.

The SNMPv3 communication processing unit 26 implements the SNMPv3 standard. For this reason, if the security scheme of the inquiry information received from the operating terminal 30 does not match the security scheme set in the image processing apparatus 20, the SNMPv3 communication processing unit 26 does not transmit response information to the operating terminal 30.

Accordingly, in the exemplary embodiment, if the security scheme of the inquiry information received from the operating terminal 30 does not match the security scheme set in the image processing apparatus 20, the trap transmission unit 28 described later uses an SNMPv3 trap to transmit response information to the operating terminal 30.

### (Trap Transmission Unit)

The trap transmission unit 28 is configured to transmit an SNMPv3 trap (event notification) to the operating terminal 30. The trap transmission unit 28 is also configured to transmit an SNMPv3 trap (event notification) to the operating terminal 30 according to the security scheme set in the image processing apparatus 20.

At this point, as described above, if the security scheme of the authentication information received from the operating terminal 30 does not match the security scheme set in the image processing apparatus 20, the SNMPv3 communication processing unit 26 does not respond to the operating terminal 30. In this case, the trap transmission unit 28 transmit response information to the operating terminal 30 in response to the inquiry information received from the operating terminal 30. At this time, the trap transmission unit 28 transmits response information to the operating terminal 30 according to the security scheme, namely SHA-1 and AES-128, set in the image processing apparatus 20.

### (Functions of Operating Terminal)

Next, the functions of the operating terminal 30 will be described.

When executing the information processing programs described above, the operating terminal 30 uses the abovementioned hardware resources to realize various functions. Specifically, as illustrated in FIG. 4, the operating terminal 30 functionally includes a settings information storage unit 32, an SNMPv3 communication processing unit 34, a trap reception unit 36, and a security scheme deciphering unit 38.

### (Settings Information Storage Unit)

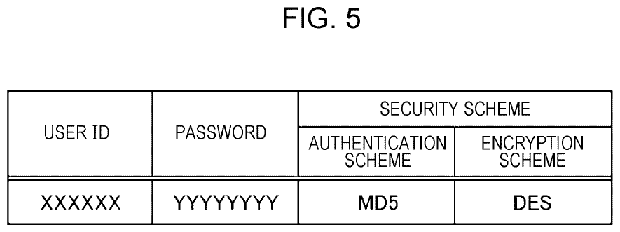

The settings information storage unit 32 stores a settings information management table in which various setting values of the operating terminal 30 are registered. FIG. 5 illustrates an example of the settings information management table. The settings information management table includes fields for user ID, password, authentication scheme, and encryption scheme.

The user ID is identification information for identifying the user of the image processing apparatus 20. The password is a string for authenticating the user of the image processing apparatus 20.

The authentication scheme is the authentication scheme set in the operating terminal 30. The authentication scheme is selected from among multiple authentication schemes usable by the operating terminal 30. As an example, the MD5, SHA-1, and SHA-256 authentication schemes are used in the operating terminal 30 according to the exemplary embodiment. Also, in the exemplary embodiment, MD5 is set as the default authentication scheme, for example.

The encryption scheme is the encryption scheme set in the operating terminal 30. The encryption scheme is selected from among multiple encryption schemes usable by the operating terminal 30. As an example, the DES, AES-128, and AES-256 encryption schemes are usable in the operating terminal 30 according to the exemplary embodiment. Also, in the exemplary embodiment, DES is set as the default encryption scheme, for example.

### (SNMPv3 Communication Processing Unit)

The SNMPv3 communication processing unit 34 is configured to transmit and receive various data to and from the image processing apparatus 20 according to SNMPv3. Specifically, the SNMPv3 communication processing unit 34 transmits inquiry information, including request information requested of the image processing apparatus 20, as an SNMPv3 information request, and receives response information from the image processing apparatus 20. As described above, the inquiry information includes authentication information of the user who uses the image processing apparatus 20, namely the user ID and password of the user.

The SNMPv3 communication processing unit 34 is also configured to transmit and receive various data to and from the image processing apparatus 20 according to an SNMPv3 security scheme. The security scheme that the SNMPv3 communication processing unit 34 uses is preset in the operating terminal 30, and is registered in the settings information management table (see FIG. 5) described above, for example. As described above, in the exemplary embodiment, MD5 and DES are set in the operating terminal 30 as the authentication scheme and the encryption scheme, respectively.

### (Trap Reception Unit)

The trap reception unit 36 receives response information transmitted using an SNMPv3 trap from the trap transmission unit 28 of the image processing apparatus 20.

### (Security Scheme Deciphering Unit)

The security scheme deciphering unit 38 deciphers the security scheme of the response information received as an SNMPv3 trap from the image processing apparatus 20. Specifically, the security scheme deciphering unit 38 deciphers the response information sequentially while changing the security scheme, that is, the combination of an authentication scheme and an encryption scheme, usable by the operating terminal 30, until the deciphering is successful.

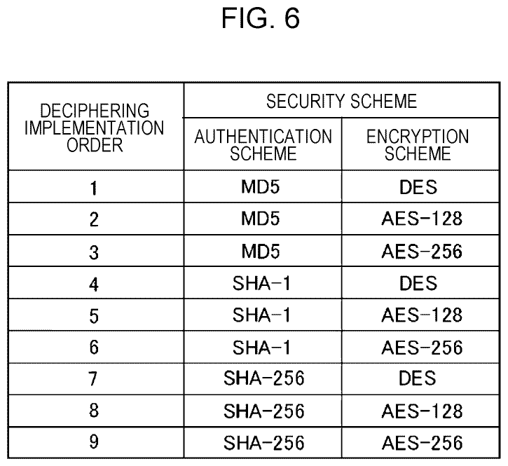

The combinations of an authentication scheme and an encryption scheme and the deciphering implementation order are predetermined. FIG. 6 illustrates an example of the combinations of an authentication scheme and an encryption scheme and the deciphering implementation order. In the example illustrated in FIG. 6, multiple encryption schemes are combined sequentially with one authentication scheme selected from among multiple authentication schemes. Next, the multiple encryption schemes are combined sequentially with another authentication scheme selected from among the multiple authentication schemes. By repeating this procedure, all of the multiple authentication schemes and the multiple encryption schemes are combined.

The higher the security level of the authentication scheme and the encryption scheme, the more time it takes to decipher the response information. Accordingly, in the exemplary embodiment, when combining an authentication scheme and an encryption scheme, an authentication scheme is selected from among the multiple authentication schemes in order of security level from low to high, that is, in order of hash value from short to long (MD5, SHA-1, SHA-256).

Similarly, when combining an authentication scheme and an encryption scheme, an encryption scheme is selected from among the multiple encryption schemes in order of security level from low to high, that is, in order of encryption key from short to long (DES, AES-128, AES-256). This increases the response information deciphering efficiency.

Note that the combinations of an authentication scheme and an encryption scheme and the deciphering implementation order may be changed, as appropriate. For example, first, the response information may be deciphered using the combination of the authentication scheme and the encryption scheme which are both of the lowest security level, and next, the response information may be deciphered using the combination of the authentication scheme and the encryption scheme which are both of the second-lowest security level. As another example, the response information may also be deciphered using a security scheme from among the multiple security schemes in order of security level from high to low.

### (Information Acquisition Process)

Next, an apparatus information acquisition process by the operating terminal 30 will be described.

In the apparatus information acquisition process by the operating terminal 30, various information is acquired from the MIB of the image processing apparatus 20 according to SNMPv3. For example, the apparatus information acquisition process is executed in the operating terminal 30 when the user of the image processing apparatus 20 logs in to the operating terminal 30 or when a request to connect with the image processing apparatus 20 is generated at the operating terminal 30. Note that the apparatus information acquisition process is an example of an apparatus information acquisition processing method.

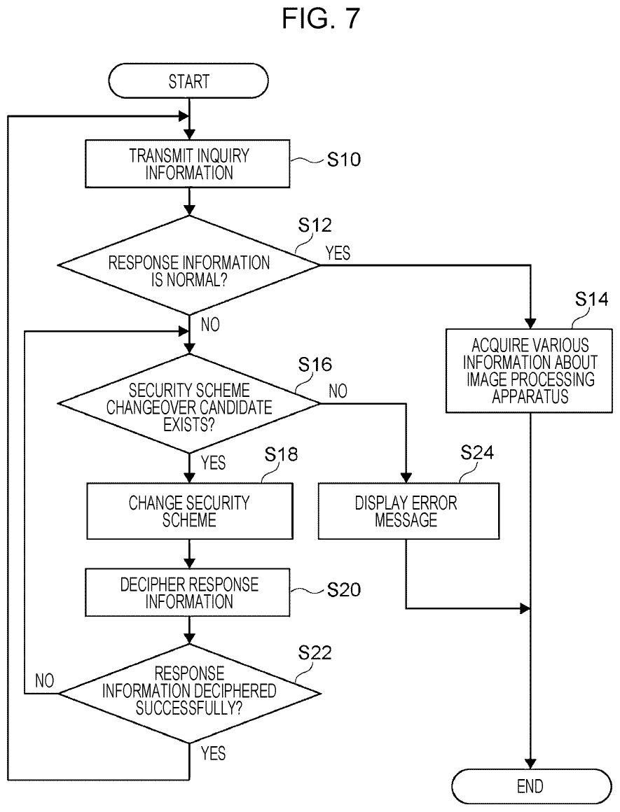

FIG. 7 illustrates an example of the apparatus information acquisition process. As illustrated in FIG. 7, first, in step S10, the CPU 70 transmits inquiry information to the image processing apparatus 20 according to SNMPv3. The inquiry information includes the authentication information of a user ID and password and request information for various information requested of the image processing apparatus 20. At this time, the CPU 70 transmits, to the image processing apparatus 20, inquiry information according to the security scheme set in the operating terminal 30, that is, with MD5 set as the authentication scheme and DES set as the encryption scheme.

Next, in step S12, the CPU 70 stands by until a response is received from the image processing apparatus 20, and proceeds to the next step in response to received response information. Specifically, if the response information received from the image processing apparatus 20 is normal, that is, if response information is received from the SNMPv3 communication processing unit 26 of the image processing apparatus 20, the CPU 70 proceeds to step S14.

In step S14, the CPU 70 deciphers the response information received from the SNMPv3 communication processing unit 26 of the image processing apparatus 20 according to the security scheme set in the operating terminal 30, and acquires various information about the image processing apparatus 20 from the deciphered response information. The CPU 70 then displays the acquired various information about the image processing apparatus 20 on the display 60 of the operating terminal 30, for example, and ends the process.

On the other hand, in step S12, if the response information received from the image processing apparatus 20 is abnormal, that is, if response information using an SNMPv3 trap is received from the image processing apparatus 20, the CPU 70 proceeds to step S16. In other words, the CPU 70 proceeds to step S16 if response information conforming to another security scheme different from the security scheme used to transmit the inquiry information from the operating terminal 30 to the image processing apparatus 20 is received from the image processing apparatus 20.

Next, in step S16, the CPU 70 determines whether or not a security scheme changeover candidate exists. Upon determining that a security scheme changeover candidate exists, the CPU 70 proceeds to step S18.

Next, in step S18, the CPU 70 changes the security scheme set in the operating terminal 30. Specifically, as illustrated in FIG. 6, for example, the combination of an authentication scheme and an encryption scheme is changed, and the security scheme in the apparatus information management table (see FIG. 5) is updated.

Next, in step S20, the CPU 70 deciphers the response information received from the image processing apparatus 20 on the basis of the changed security scheme.

Next, in step S22, the CPU 70 determines whether or not the response information has been deciphered successfully. Upon determining that the response information has not been deciphered successfully, the CPU 70 returns to step S16.

In step S16, upon determining that a security scheme changeover candidate does not exist, the CPU 70 proceeds to step S24.

In step S24, the CPU 70 displays an error message indicating the failure to acquire various information about the image processing apparatus 20 on the display 80 of the operating terminal 30, for example, and ends the process.

On the other hand, in step S22, upon determining that the response information has been deciphered successfully, the CPU 70 returns to step 510. Then, in step S10, the CPU 70 retransmits inquiry information to the image processing apparatus 20 according to the security scheme for which the response information has been deciphered successfully, that is, the same security scheme as the response information received as an SNMPv3 trap from the image processing apparatus 20.

### (Response Process)

Next, a response process by the image processing apparatus 20 will be described.

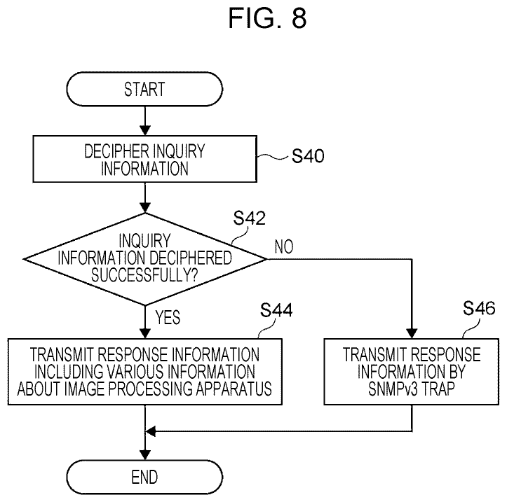

The response process illustrated in FIG. 8 is executed in the image processing apparatus 20 when the image processing apparatus 20 receives inquiry information from the operating terminal 30. Note that the response process is an example of a response processing method.

First, in step S40, the CPU 50 deciphers the inquiry information received from the operating terminal 30 according to the security scheme, namely SHA-1 and AES-128, set in the image processing apparatus 20.

Next, in step S42, the CPU 50 determines whether or not the inquiry information has been deciphered successfully. Upon determining that the inquiry information has been deciphered successfully, the CPU 50 proceeds to step S44.

Next, in step S44, the CPU 50 authenticates the user with the user ID and password of the user included in the inquiry information. The CPU 50 then transmits response information according to the result of authenticating the user to the operating terminal 30, and ends the process. That is, if the user is authenticated successfully, the CPU 50 transmits response information including various information about the image processing apparatus 20 requested by the operating terminal 30 to the operating terminal 30, and ends the process.

On the other hand, if the user is not authenticated successfully, the CPU 50 transmits response information including information indicating that authentication was unsuccessful to the operating terminal 30, and ends the process. At this time, the CPU 50 does not transmit various information about the image processing apparatus 20 requested by the operating terminal 30 to the operating terminal 30.

On the other hand, in step S42, upon determining that the inquiry information has not been deciphered successfully, the CPU 50 proceeds to step S46.

Next, in step S46, the CPU 50 uses an SNMPv3 trap to transmit response information to the operating terminal 30, and ends the process. At this time, the CPU 50 transmits response information to the operating terminal 30 according to the security scheme set in the operating terminal 30, that is, the security scheme used to decipher the inquiry information received from the operating terminal 30.

### (Exemplary Modifications)

Next, exemplary modifications of the exemplary embodiment above will be described.

In the exemplary embodiment above, the SNMPv3 security scheme used by the image processing apparatus 20 and the operating terminal 30 is a combination of an authentication scheme and an encryption scheme. However, the SNMPv3 security scheme used by the image processing apparatus 20 and the operating terminal 30 is not limited to a combination of an authentication scheme and an encryption scheme, and may also be an authentication scheme only or an encryption scheme only, for example.

Also, the operating terminal 30 according to the exemplary embodiment above identifies the security scheme of the image processing apparatus 20 by deciphering response information received as an SNMPv3 trap from the image processing apparatus 20. However, the operating terminal 30 may also identify the security scheme of the image processing apparatus 20 by querying the image processing apparatus 20 about the security scheme, for example.

Also, in the exemplary embodiment above, the image processing apparatus 20 and the operating terminal 30 transmit and receive various data according to SNMPv3. However, the image processing apparatus 20 and the operating terminal 30 are not limited to SNMPv3 and may also transmit and receive various data according to another communication protocol in which security schemes are usable.

Also, in the exemplary embodiment above, the information processing apparatus is an image processing apparatus as an example. However, the information processing apparatus is not limited to an image processing apparatus, and may also be a server apparatus, network-enabled equipment, or the like which is communicatively connected to the operating terminal over a network and in which SNMPv3 or other security schemes are usable.

In the exemplary embodiment above, the term “processor” refers to hardware in abroad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The exemplary embodiment above describes a form in which each program is installed in ROM or storage, but is not limited thereto. Each program according to the exemplary embodiment above may also be provided by being recorded onto a computer-readable storage medium. For example, each program according to the exemplary embodiment above may be provided by being recorded on an optical disc, such as a Compact Disc-Read-Only Memory (CD-ROM) or a Digital Versatile Disc-Read-Only Memory (DVD-ROM), or by being recorded on a semiconductor memory, such as Universal Serial Bus (USB) memory or a memory card. Also, each program according to the exemplary embodiment above may be acquired from an external apparatus via a communication I/F.

Also, the exemplary embodiment above describes a case in which the processing in the image processing apparatus 20 and the operating terminal 30 is achieved by a software configuration using a computer by executing a program, but the present disclosure is not limited thereto. For example, the processing in the image processing apparatus 20 and the operating terminal 30 may also be achieved by a hardware configuration, or by a combination of a hardware configuration and a software configuration.

Otherwise, the configurations of the image processing apparatus 20 and the operating terminal 30 described in the exemplary embodiment above are examples, and obviously, unnecessary portions may be removed or new portions may be added within a scope that does not depart from the gist of the present disclosure.

Also, the flow of the processing in the image processing apparatus 20 and the operating terminal 30 described in the exemplary embodiment above is an example, and obviously, unnecessary steps may be removed, new steps may be added, or the processing sequence may be rearranged within a scope that does not depart from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising
a processor configured to:
transmit inquiry information from an operating terminal of an information processing apparatus to the information processing apparatus according to a predetermined security scheme; and
upon receiving response information according to another security scheme different from the security scheme from the information processing apparatus, transmit the inquiry information to the information processing apparatus according to the same security scheme as the other security scheme.
   (((2)))

The information processing system according to (((1))), wherein
the processor is configured to
designate that a security scheme used to successfully decipher the response information is the same security scheme as the other security scheme.
   (((3)))

The information processing system according to (((2))), wherein
the processor is configured to
decipher the response information sequentially while changing the security scheme until the response information is deciphered successfully.
   (((4)))

The information processing system according to (((3))), wherein
the processor is configured to
decipher the response information using a security scheme from among a plurality of security schemes in order of security level from low to high.
   (((5)))

The information processing system according to any one of (((1))) to (((4))), wherein
the security scheme is a combination of an authentication scheme and an encryption scheme.
   (((6)))

The information processing system according to (((5))), wherein
the processor is configured to
decipher the response information sequentially while changing the combination of an authentication scheme and an encryption scheme.
   (((7)))

The information processing system according to any one of (((1))) to (((6))), wherein
the processor is configured to
transmit the inquiry information as an SNMPv3 information request to the information processing apparatus; and receive the response information from the information processing apparatus as an SNMPv3 trap.
   (((8)))

An information processing program causing a computer to execute a process comprising:
transmit inquiry information from an operating terminal of an information processing apparatus to the information processing apparatus according to a predetermined security scheme; and
upon receiving response information according to another security scheme different from the security scheme from the information processing apparatus, transmit the inquiry information to the information processing apparatus according to the same security scheme as the other security scheme.
   (((9)))

An information processing system comprising
a processor configured to:
receive inquiry information according to a prescribed security scheme from an operating terminal of an information processing apparatus to the information processing apparatus; and
transmit, if the received inquiry information is not deciphered successfully, response information to the operating terminal in response to the inquiry information according to the security scheme used for deciphering.
   (((10)))

The information processing system according to (((9))), wherein
the processor is configured to
receive the inquiry information as an SNMPv3 information request; and transmit the response information as an SNMPv3 trap to the operating terminal.
   (((11)))

An information processing program causing a computer to execute a process comprising:
receive inquiry information according to a prescribed security scheme from an operating terminal of an information processing apparatus to the information processing apparatus; and
transmit, if the received inquiry information is not deciphered successfully, response information to the operating terminal in response to the inquiry information according to the security scheme used for deciphering.

What is claimed is:

1. An information processing system comprising:
a processor configured to:
transmit inquiry information from an operating terminal of an information processing apparatus to the information processing apparatus according to a predetermined security scheme; and
upon receiving response information according to another security scheme different from the security scheme from the information processing apparatus, transmit the inquiry information to the information processing apparatus according to the same security scheme as the other security scheme.

2. The information processing system according to claim 1, wherein the processor is configured to designate that a security scheme used to successfully decipher the response information is the same security scheme as the other security scheme.

3. The information processing system according to claim 2, wherein the processor is configured to decipher the response information sequentially while changing the security scheme until the response information is deciphered successfully.

4. The information processing system according to claim 3, wherein the processor is configured to decipher the response information using a security scheme from among a plurality of security schemes in order of security level from low to high.

5. The information processing system according to claim 2, wherein the security scheme is a combination of an authentication scheme and an encryption scheme.

6. The information processing system according to claim 5, wherein the processor is configured to decipher the response information sequentially while changing the combination of an authentication scheme and an encryption scheme.

7. The information processing system according to claim 1, wherein the processor is configured to:
transmit the inquiry information as an SNMPv3 information request to the information processing apparatus; and
receive the response information from the information processing apparatus as an SNMPv3 trap.

8. The information processing system according to claim 2, wherein the processor is configured to:
transmit the inquiry information as an SNMPv3 information request to the information processing apparatus; and
receive the response information from the information processing apparatus as an SNMPv3 trap.

9. The information processing system according to claim 3, wherein the processor is configured to:
transmit the inquiry information as an SNMPv3 information request to the information processing apparatus; and
receive the response information from the information processing apparatus as an SNMPv3 trap.

10. The information processing system according to claim 4, wherein the processor is configured to:
transmit the inquiry information as an SNMPv3 information request to the information processing apparatus; and
receive the response information from the information processing apparatus as an SNMPv3 trap.

11. The information processing system according to claim 5, wherein the processor is configured to:
transmit the inquiry information as an SNMPv3 information request to the information processing apparatus; and
receive the response information from the information processing apparatus as an SNMPv3 trap.

12. The information processing system according to claim 6, wherein the processor is configured to:
transmit the inquiry information as an SNMPv3 information request to the information processing apparatus; and
receive the response information from the information processing apparatus as an SNMPv3 trap.

13. A non-transitory computer readable medium storing a program causing a computer to execute a process comprising:
transmitting inquiry information from an operating terminal of an information processing apparatus to the information processing apparatus according to a predetermined security scheme; and
upon receiving response information according to another security scheme different from the security scheme from the information processing apparatus, transmitting the inquiry information to the information processing apparatus according to the same security scheme as the other security scheme.

14. An information processing system comprising:
a processor configured to:
receive inquiry information according to a prescribed security scheme from an operating terminal of an information processing apparatus to the information processing apparatus; and
transmit, if the received inquiry information is not deciphered successfully, response information to the operating terminal in response to the inquiry information according to the security scheme used for deciphering.

15. The information processing system according to claim 9, wherein the processor is configured to:
receive the inquiry information as an SNMPv3 information request; and
transmit the response information as an SNMPv3 trap to the operating terminal.
